(19) United States
(12) Patent Application Publication
(10) Pub. No.: US 2023/0166272 A1
(43) Pub. Date: Jun. 1, 2023

(54) NOZZLE ASSEMBLY FOR COLD SPRAY

(71) Applicant: The Government of the United States of America, as represented by the Secretary of the Navy, Arlington, VA (US)

(72) Inventors: Robert Francis Brown, Summerland Key, FL (US); Gregory M. Smith, Alexandria, VA (US); Christopher Brady, Bradenton, FL (US)

(21) Appl. No.: 17/938,681

(22) Filed: Oct. 7, 2022

Related U.S. Application Data
(60) Provisional application No. 63/264,761, filed on Dec. 1, 2021.

(51) Int. Cl. B05B 1/06; B05B 15/18; B05B 15/65

(52) U.S. Cl. CPC B05B 1/06; B05B 15/18; B05B 15/65

(57) ABSTRACT

A nozzle assembly is provided that includes two sections, the first section may be contoured and the second section may be a converging and diverging section that is downstream from the second section in the direction of gas flow. The contoured section, with a range of bend angles, allows for non-line-of-sight cold spray deposition, thereby providing location-specific control of the cold spray deposition process.

### CROSS-REFERENCE TO RELATED APPLICATIONS

This application claims the benefits of U.S. Provisional Application No. 63/264,761 filed on Dec. 1, 2021, the entirety of which is incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing Navy Case Number 113070-US2.

### BACKGROUND

Cold spray deposition is a material deposition technique that enables powdered feedstock material to be heated, accelerated towards a target substrate, and eventually deposited in layers to build a coating. To achieve uniform thickness in the coating, the spraying nozzle may be scanned along the substrate in a line-of-sight process. Traditional nozzles that deliver powder or feedstock material for cold spray deposition are straight and are designed to accelerate the feedstock material, propelled by a high velocity gas stream, towards the target substrate for maximum adhesion and/or cohesion. However, in many applications, the target substrate may have complex geometries (e.g., interior surfaces of pipes) and line-of-sight deposition is insufficient for these applications.

### SUMMARY

This Summary is intended to introduce, in simplified form, a selection of concepts that are further described in the Detailed Description. This Summary is not intended to identify key or essential features of the claimed subject matter, nor is it intended to be used as an aid in determining the scope of the claimed subject matter. Instead, it is merely presented as a brief overview of the subject matter described and claimed herein.

Embodiments described herein are directed to a nozzle assembly, for use with cold spray equipment. The nozzle assembly includes two sections, one being a tubular section that may be contoured or bent (e.g., variable from 10 to 180 degrees) and the other being a converging and diverging section that is downstream in the direction of the gas flow from the tubular section. This nozzle assembly allows for non-line-of-sight cold spray deposition, thereby providing greater location-specific control of the cold spray deposition process.

In an embodiment, a nozzle assembly is provided that includes a first section that has a flanged end and a first coupling end, and a second section that has an internal converging section and an internal diverging section to allow powder particles to be accelerated toward a target substrate. The second section may include an output end of the nozzle assembly and a second coupling end configured to be coupled with the first coupling end.

Another embodiment is directed to a cold spray system. The system includes a cold spray gun and a nozzle assembly that includes a first section that has a flanged end and a first coupling end. The nozzle assembly further includes a second section that has an internal converging section and an internal diverging section to allow powder particles to be accelerated toward a target substrate, the second section comprising an output end of the nozzle assembly and a second coupling end configured to be coupled with the first coupling end.

Further features and advantages of the invention, as well as the structure and operation of various embodiments are described in detail below with reference to the accompanying drawings.

### BRIEF DESCRIPTION OF THE DRAWINGS

FIG. 1 depicts an orthogonal view of a nozzle assembly, according to an example embodiment.

FIG. 2 depicts a cross-sectional view of the nozzle assembly of FIG. 1.

FIG. 3 depicts an example cold spray system.

FIG. 4 depicts an orthogonal view of a nozzle assembly with a contoured section.

FIG. 5 depicts a cross-sectional view of the nozzle assembly of FIG. 4.

FIG. 6 depicts an orthogonal view of a nozzle assembly with a contoured section.

FIG. 7 depicts a cross-sectional view of the nozzle assembly of FIG. 6.

FIG. 8 depicts an orthogonal view of a converging and diverging section of a nozzle assembly.

FIG. 9 depicts a cross-sectional view of the section of FIG. 8.

FIG. 10 depicts an orthogonal view of another section, configured to have a variable bend degree, of a nozzle assembly.

FIG. 11 depicts a perspective view of the section of FIG. 10.

FIG. 12 depicts a cross-sectional view of the section of FIG. 10.

FIG. 13 depicts a cross-sectional view of a section with bend degree of 0.

FIG. 14 depicts an orthogonal view of a section with bend degree of 20.

FIG. 15 depicts an orthogonal view of a section with bend degree of 90.

FIG. 16 depicts a cross-sectional view of a section with a bend degree of 180.

FIG. 17 depicts an exploded view of a nozzle assembly, according to an example embodiment.

FIG. 18 depicts an orthogonal view of the nozzle assembly of FIG. 17.

FIG. 19 depicts a cross-sectional view of a first section of a nozzle assembly.

FIG. 20 depicts a cross-sectional view of an adapter.

FIG. 21 depicts a cross-sectional view of a second section of a nozzle assembly.

### DETAILED DESCRIPTION

### Definitions

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, it is submitted that it is within the knowledge of one skilled in the art to effect such feature, structure, or characteristic in connection with other embodiments whether or not explicitly described.

In describing and claiming the disclosed embodiments, the following terminology will be used in accordance with the definition set forth below.

As used herein, the singular forms “a,” “an,” “the,” and “said” do not preclude plural referents, unless the content clearly dictates otherwise.

As used herein, the term “and/or” includes any and all combinations of one or more of the associated listed items.

As used herein, the term “about” or “approximately” when used in conjunction with a stated numerical value or range denotes somewhat more or somewhat less than the stated value or range, to within a range of ±10% of that stated.

Terminology used herein should not be construed as being “means-plus-function” language unless the term “means” is expressly used in association therewith.

### Overview

Cold spray is an emerging materials deposition process, first patented in the 1990s with accelerated development in the early 2000s. Cold spray allows for metallic and metallic-ceramic coatings to be formed from power feedstock material that is not melted. For cold spray, hot gasses are forced through a de Laval nozzle (a converging/diverging design) to accelerate deposition gas and entrapped feedstock particles towards a target ahead of the torch or cold spray gun opening. The accelerated feedstock particles are then deposited in layers on the target to build a coating. Typical nozzles are made from hard, brittle materials that are impossible or impractical to bend. Thus, because of the fabrication material and the converging/diverging (CD) design, these nozzles are traditionally configured to be straight.

One of the many longstanding challenges with cold spray deposition is the line-of-sight nature of the coating process, in contrast to other surface coating techniques like physical or chemical vapor deposition. Applications involving targets with complex geometries (e.g., interiors of pipes, valves, piping systems) or difficult to reach targets, would benefit greatly from a non-line-of-sight deposition process.

Embodiments described herein are directed to a nozzle assembly, for use with a cold spray system. In an example embodiment, the nozzle assembly includes two sections. The first section is one that may be contoured or bent (e.g., variable in degree), depending on the application. The first section may also be straight, with a bend degree of 0, if desired. The second section is a converging and diverging (CD) section (i.e., having an internal convergent and divergent design) that is downstream in the direction of gas flow from the first section. This nozzle assembly allows for non-line-of-sight cold spray deposition, thereby providing greater location-specific control of the cold spray deposition process and enable coating of otherwise hard to reach locations. These sections may be configured to have a range of bend angles, sizes, and lengths while still providing particle velocity control via fluid mechanics. In an example embodiment, the first and second sections may be directly coupled. In another example embodiment, the first and second sections may be coupled via an adapter and a coupling nut.

Because the gas stream of the cold spray process can be relatively easily controlled with conduit geometry and because small size particles tend to follow the gas flow contour, especially when constrained radially, it is possible to tailor the nozzle shape (e.g., bend angle) to allow for angled particle flow. Additionally, by locating the CD feature downstream of the bend radius, particle flow is ensured as the gases and feedstock particles do not have to flow through a bent or contoured section of the nozzle assembly in an accelerated state. The CD feature placement also improves the life and performance of the nozzle assembly as the contoured section is not subjected to the acceleration of particles and gases, which occurs in the CD section that is downstream from the contoured section.

Accordingly, the nozzle assembly with a variable bend allows for targeted deposition in areas where the prior line-of-sight straight nozzle approach is not sufficient. Bent nozzles also allows for targeted material deposition in hard to reach locations, resulting in increased adhesion and cohesion strengths that straight nozzles are not able to obtain. The nozzle assembly may be configured with multiple sections (not just two) to allow for greater flexibility and deposition control. Furthermore, the different sections of the nozzle assembly are not limited in size or length, and may be varied in lengths and diameters compared to typical cold spray nozzles to accommodate higher pressure air or gas of various composition and/or allow for either fine area or wide area deposition.

The nozzle assembly may be adapted with an air-cooled heat exchanger (e.g., U.S. patent application Ser. No. 17/354,780 filed on Jun. 22, 2021, entitled “Cooling System and Fabrication Method thereof,” the entirety of which is incorporated herein by reference) for additional particle kinetic energy control with higher gas temperatures. In addition, the nozzle assembly may be used in a cold spray process that has an accompanying post-treatment process (e.g., U.S. patent application Ser. No. 17/242,445 filed on Apr. 28, 2021, entitled “Post-Treatment via Ultrasonic Consolidation of Spray Coatings,” the entirety of which is incorporated herein by reference).

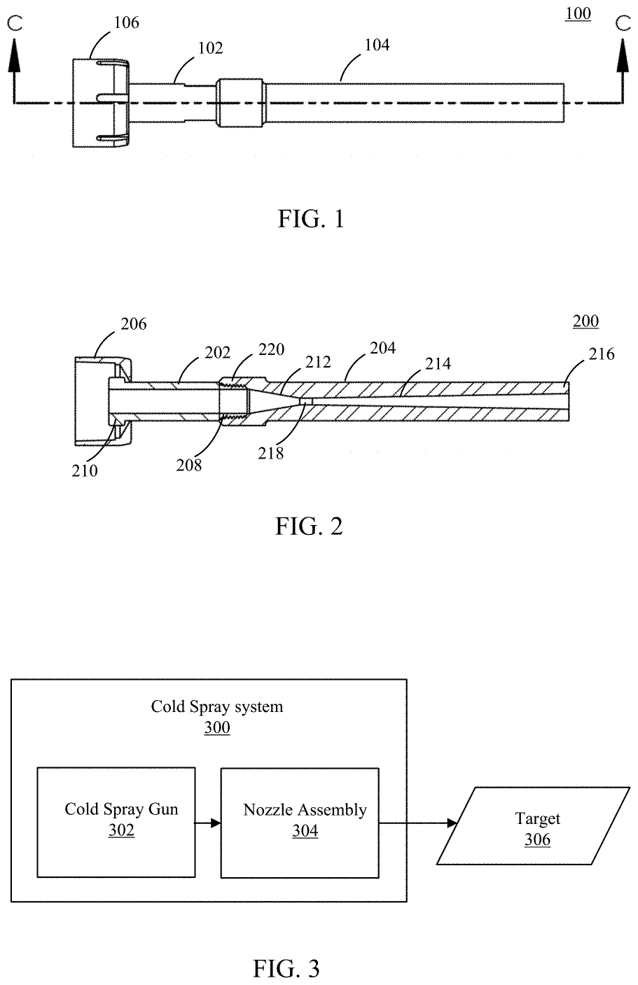

FIG. 1 depicts an orthogonal view of a nozzle assembly 100, according to an embodiment. Nozzle assembly 100 may include a first section 102 that is tubular and has two ends. One end of first section 102 is configured to be connected to a second section 104 and the other end is configured to be connected to coupling nut 106.

FIG. 2 depicts a cross-sectional view along line C-C of nozzle assembly 100 of FIG. 1. Nozzle assembly 200 shown in FIG. 2 may include first section 202 that is directly coupled to second section 204 and coupling nut 206. First section 202 may include a first coupling end 208 and a flanged end 210. Second section 204 may include a second coupling end 220 and an output end 216, which is the output of nozzle assembly 200, from which gases and feedstock particles may be discharged to form a coating on a target.

To couple first section 202 to second section 204, first coupling end 208 and second coupling end 220 may be connected together in a tight fit such that the connecting surfaces are as close together as possible. In an embodiment, second coupling end 220 may be configured to receive first coupling end 208. For example, second coupling end 220 may include internal threads and a larger diameter for receiving first coupling end 208, which may include external threads, as shown in FIG. 2. Thus, the external and internal threads are configured to lock first section 202 and second section 204 together. First coupling end 208 and second coupling end 220 may be pitched so that the external shoulder of first section 202 is flushed against the internal shoulder of second section 204 such that there is no gap between the two sections or any disparities in the connecting surfaces that may trap particles or promote build up inside the nozzle assembly.

In an embodiment, coupling nut 206 may be placed on first section 202 and slid down its length to form a tight fit with flanged end 210 before first section 202 is coupled to second section 204. This is because the external diameter of second coupling end 220 may be too large, and therefore would not allow coupling nut 206 to pass through from output end 216 to flanged end 210. In an embodiment, a sealant and/or a gasket may be placed adjacent to the second coupling end 220, between first section 202 and second section 204 to secure the two sections together and prevent leakage. In another embodiment, a fastening and/or locking means, such as an adhesive (e.g., Loctite® threadlocker), may be placed on connecting surfaces of first section 202 and/or second section 204 to lock and seal the two sections together. In other embodiments, other means of coupling the different components of nozzle assembly 200 may be utilized.

As shown in FIG. 2, second section 204 may include an internal converging section 212 connected to a throat 218 that is connected to a diverging section 214. Thus, second section 204 may also be referred to as the converging and diverging (CD) section. Coupling nut 206 is configured to connect first section 202 to a cold spray system via flanged end 210. Coupling nut 206 may include a countersunk hole or a counterbored hole to allow it to slide up the length of first section 202 and stop at flanged end 210.

FIG. 3 depicts an example cold spray system 300. System 300 may include, among other components not shown in FIG. 3, a cold spray torch or gun 302 coupled a nozzle assembly 304. A coupling nut, such as coupling nut 206 shown in FIG. 2, may be used to couple nozzle assembly 304 to cold spray gun 302. In operation, cold spray system 300 may be utilized for solid-state powder deposition, which involves accelerating powder feedstock particles (e.g., 10-100 μm in size) through nozzle assembly 304 with a compressible carrier gas (e.g., helium, nitrogen or air) or a combination of gases to achieve supersonic gas velocities for favorable deposition of coating layer(s) on a target 306. Target 306 may be a substrate or any surface to be repaired, enhanced, or modified in some manner, including a surface that has previously been coated. For example, the substrate may be a surface of a piece of field equipment, rotating components (e.g., shafts, rollers, etc.), hydraulic parts, engines, turbines, cavities, or medical devices to be repaired, enhanced, or manufactured.

Feedstock materials for cold spray include pure metals (e.g., aluminum, nickel, copper, or titanium), metal alloys, polymers, and hybrid materials (e.g., metal-metal, metal-alloy, metal-ceramic, or metal-graphene/carbon nanotubes). These materials allow for the application of different coatings, for example, to repair a component with similar or improved materials or to form desired features into the cold spray coatings deposited on a substrate or a target surface of the component. Modifying or repairing a component may be a more economical choice than replacing that component. The cold spray process may be a useful alternative for brush plating, electroplating, weld repairs, etc., because it is a quick process and can build material reliably in a relatively short time.

The internal geometries of nozzle assembly 304, particularly, the CD section is designed to convert heat energy of the carrier gas and feedstock powder flow into kinetic energy. The carrier gas, at an established pressure and temperature, enters nozzle assembly 304 CD section, specifically the converging section, which compresses the gas at subsonic velocity through its length until the gas reaches the constriction or throat (e.g., through 218 shown in FIG. 2). The particle velocity is relatively slow at this location, compared to the gas velocity, and the particles continue to absorb heat from the carrier gas. As the gas exits the throat and enters the diverging section of the CD section, pressure and temperature reduce, while velocities increases to near or supersonic velocities. Particles may accelerate in the gas stream from the end of the throat to nozzle exit (e.g., output end 216 shown in FIG. 2), where compressible gas velocities, V_{g}, follow equation 1:

V_{g}=M\sqrt{γRT} (equation 1)

where R is the specific gas constant, T is the temperature, γ is the specific heat ratio (e.g., 1.4 for diatomic nitrogen, and 1.66 for monatomic helium), and M is the Mach number. Gas velocities may also be influenced by aspects of the nozzle throat as follows.

$$\frac{A}{{A}^{*}} = \frac{1}{M} {( [ \frac{2}{γ + 1} ] [ 1 + ( \frac{γ - 1}{2} ) {M}^{2} ] )}^{( γ + 1 ) / [ 2 ( γ - 1 ) ]} \qquad ( equation 2 )$$

where A is the calculated cross-sectional area along the nozzle, and A* is the area of the nozzle throat. Employing gas stream velocities, pressures, and temperatures, the particle velocity (Vₚ) may be modeled based on the estimated particle drag coefficient (C_{d}), mass of the particle (m), gas velocity (V_{g}), cross sectional area of a particle (Aₚ), and the assumption that the particle velocity is much less than the gas velocity, as follows.

$${V}_{p} = {V}_{g} \sqrt{\frac{{C}_{d} {A}_{p} {ρ}_{g}}{m}} \qquad ( equation 3 )$$

where ρ_{g} is the gas density. Particle drag is dependent on particle density, size and shape, where the larger or the more irregular the shape, drag increases and particle velocity or kinetic energy decreases. This aspect is important, especially when carrier gas temperatures and pressures are low, such as for portable cold spray systems. Additionally, the particle temperature is subsequently lower than its melting point upon exit from the nozzle, thus resulting in limited oxide formation, in contrast to inflight particles of many thermal spray processes. This is a desirable aspect of cold spray, where the feedstock properties are retained during deposition and particle exit velocities can range from 500-1200 m/s. The basis of particle velocity and momentum create the relatively high kinetic energy, coupled with the cold spray fluid mechanics, which is the driving force for the critical velocity window of deposition, determine coating adhesion, cohesion, and deposit compaction and efficiency. The solid-state particle undergoes deformation and adiabatic shear instability as it impacts and craters into the target substrate, which consequently results in substrate deformation, improving first layer adhesion.

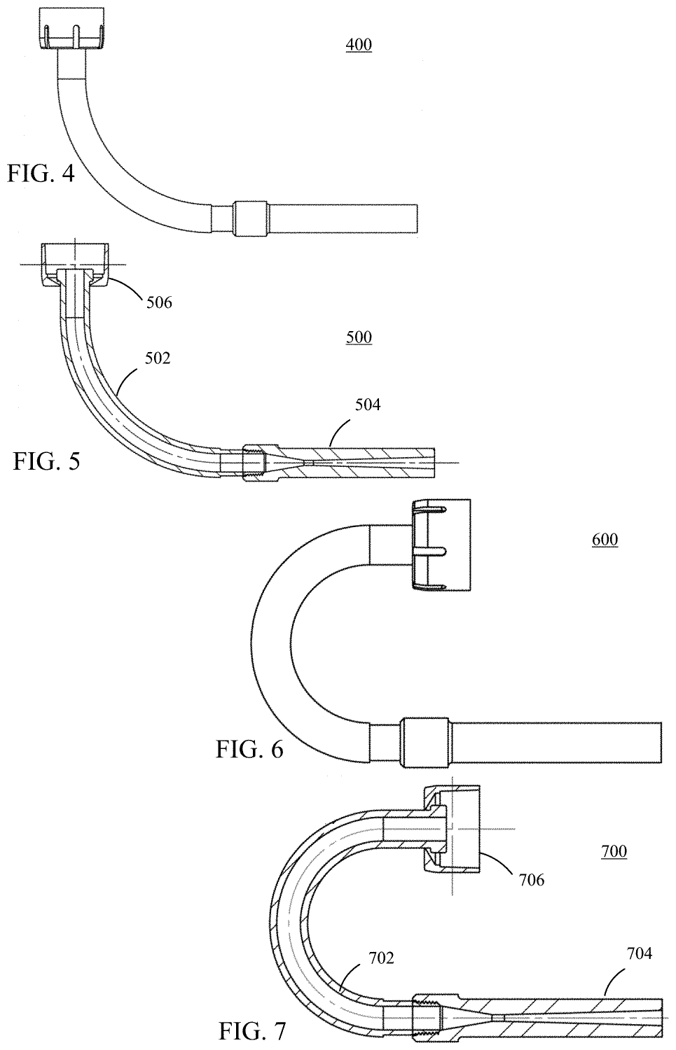

As shown in FIG. 2, first section 202 is a straight section. However, in other embodiments, section 202 may be a contoured section with a variable degree of bend (e.g., 10°, 20°, 45°, 90°, 180°, 360°) with no limitation on the bend angle. This enables the nozzle assembly to deposit material in a non-line-of-sight process, particularly useful for hard to reach locations and/or on components with complex geometries not suitable for line-of-sight deposition. For example, FIGS. 4-7 illustrate different embodiments of the nozzle assembly described herein, each of which includes a contoured section upstream from a CD section.

FIG. 4 depicts an orthogonal view of a nozzle assembly 400 with a contoured section. FIG. 5 depicts a cross-sectional view of nozzle assembly 400 shown in FIG. 4. Nozzle assembly 500 shown in FIG. 5 includes first section 502, second section 504, and coupling nut 506. As shown in FIG. 5, first section 502 is a contoured section with a bend angle of 90°.

FIG. 6 depicts an orthogonal view of a nozzle assembly 600 with a contoured section. FIG. 7 depicts a cross-sectional view of nozzle assembly 600 shown in FIG. 6. Nozzle assembly 700 shown in FIG. 7 includes first section 702, second section 704, and coupling nut 706. As shown in FIG. 7, first section 702 is a contoured section with a bend angle of 180°.

The embodiments shown in FIGS. 4-7 are intended to be example embodiments and are not intended to be limiting. The sizes/diameters (internal and external), lengths, bend radius or angle of bend for each section may be configured for a particular application and/or to control particle velocity via fluid mechanics, governed by the above equations. The nozzle assembly may be configured in any logical manner, for example, more than two sections may be connected together in a series as long as they do not become too cumbersome as to inhibit gas and/or particular flow. In this case, the ends of the different sections may need to be adapted such that the desired sections may be appropriately joined together with a first section connected to a coupling nut and with the last section being a CD section, with respect to the direction of gas/particle flow. For example, in a nozzle assembly with three sections, the middle section may be a straight or contoured section with internal threads on one end and external threads on the other end.

One challenge with the cold spray process is that there is a propensity for accelerated particles to stick to or adhere or adsorb onto the internal walls of the cold spray nozzle. This is typically an issue for softer metallic materials, such as aluminum and copper, or when higher operating temperatures are used for cold spray. One way to address this challenge is to apply a protective treatment to the surfaces of one or more sections of the nozzle assembly to reduce particular sticking via case-hardening or hardfacing. Such treatment may also reduce wear-and-tear of the treated surfaces as the treatment may be erosion and/or corrosion resistant. In addition, such treatment and/or the choice of material from which the nozzle assembly is fabricated, may have an effect on process characteristics, such as materials compatibility or wettability. Thus, in embodiments, a treatment configured to produce a certain effect, such as to improve wear properties and/or to reduce degradation and particle sticking, or to impact process characteristics, may be provided on one or more internal or external surfaces of one or more sections of the nozzle assembly. For the hardfacing process, many materials may be utilized, for example, nitride, titanium nitride, boron nitride, or diamond-like carbon. It may be more beneficial to apply such treatment to the internal walls of the different sections of the nozzle assembly, especially if the material or process is costly or time consuming and thus should be utilized sparingly. For example, it may be more economical and efficient to replace a section (e.g., a non-CD section) rather than spend the resources to protect that section with a treatment. However, in certain applications (e.g., harsh operating environments), the exterior surfaces may benefit from such treatment. Different surfaces and/or sections may undergo the same or different treatments, depending on the application.

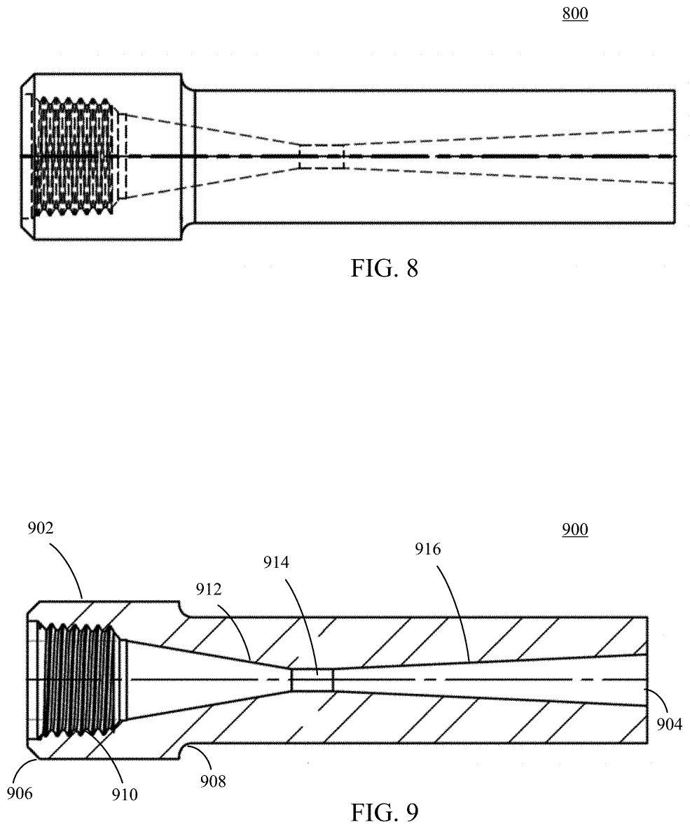

The different sections of a nozzle assembly will be described below in connection with FIGS. 8-16. FIG. 8 depicts an orthogonal view of a CD section 800 of a nozzle assembly. FIG. 9 depicts a cross-sectional view of CD section 800 shown in FIG. 8. As shown in FIG. 9, CD section 900 includes a threaded end 902, with internal threads, configured to receive the externally threaded end of another section. CD section 900 also includes output end 904, from which gas(es) and feedstock particles are discharged onto a target substrate. CD section 900 may be made from a metal or metal alloy (e.g., carbon steel, stainless steel, tungsten carbide) via any suitable process, for example, machining, extrusion, etc. As CD section 900 have to withstand the acceleration of gases and particles at high velocities, the material(s) used for fabricating may be wear-resistant. As mentioned above, the sizes/diameters and lengths of CD section 900 may be customized for different applications with no limitation beyond what is required to maintain process control (e.g., velocity control) via fluid dynamics. As shown in FIG. 9, CD section 900 may include an exterior chamfered edge 906 at threaded end 902 and an exterior filleted edge 908 at a predetermined distance (e.g., 0.723 inches) down the length of CD section 900. CD section 900 may also include a threaded portion 910. In embodiments, threaded portion 910 may be configured in any manner and/or standard, for example, with ¼″-18 NPTF. In an embodiment, the interior diameter of threaded portion 910 may be 0.375 inches with a length of 0.473 inches. CD section 900 may also include a converging section 912 (e.g., 0.787 inches in length), a throat section 914 (0.197 inches in length and 0.106 inches in diameter), and a diverging section 916 (e.g., 0.244 inches in diameter at output end 904). The length of diverging section 916 may vary, depending on the application, and may include example lengths of 1.5, 2.5, 4.016 or 5.516 inches. The length of diverging section 916 and the diameter at output end 904 may be varied, individually or in combination, to allow for fine area or wide area deposition and/or usage of different types and/or composition of gases.

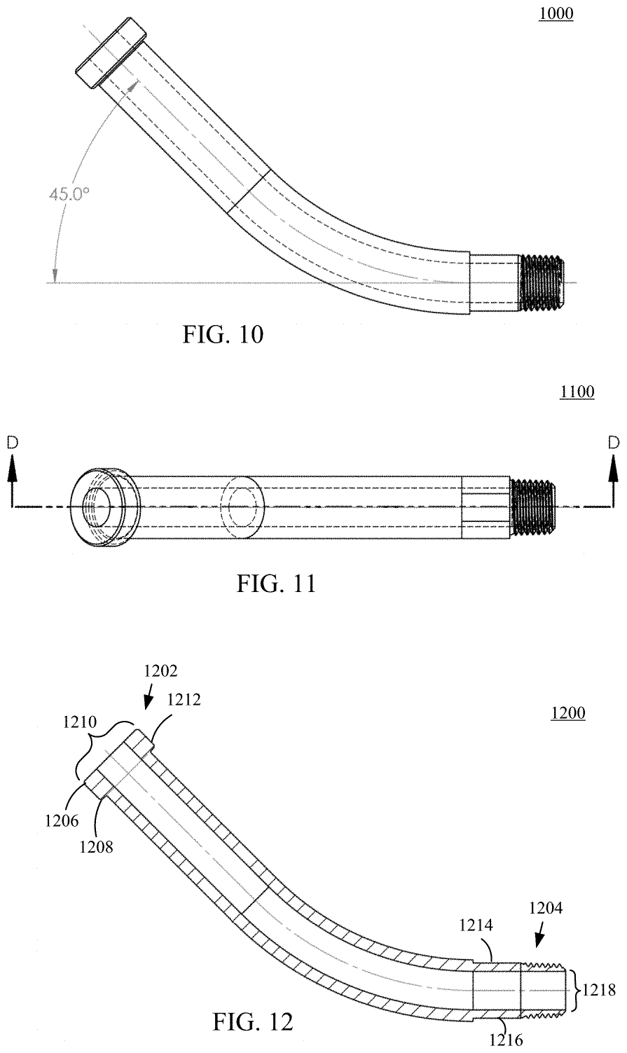

FIGS. 10-12 illustrate different views of a contoured section of a nozzle assembly. FIG. 10 depicts an orthogonal view of a section, configured to have a variable bend degree, of a nozzle assembly. As shown in FIG. 10, the bend degree of contoured section 1000 is 45°. FIG. 11 depicts a perspective view of contoured section 1000 of FIG. 10. As shown in FIG. 11, contoured section 1100 is configured to be tubular with substantially the same internal diameter throughout its length. FIG. 12 depicts a cross-sectional view along line D-D of contoured section 1100 shown in FIG. 11. Contoured section 1200 shown in FIG. 12 includes a flanged end 1202 and an externally threaded end 1204, configured to be received by another section (e.g., a CD section) for coupling the two sections together. Flanged end 1202 may be coupled to a cold spray system via a coupling nut.

Contoured section 1200 may be made from a metal or metal alloy (e.g., carbon steel, stainless steel, etc.) that is pliable and/or ductile to allow for bending. Feedstock particles may flow into contoured section 1200 from the cold spray system at a relatively slow speed and may be fairly warm. As the particles travel downstream, they cool off and accelerate in velocity at the CD section. Thus, contoured section 1200 does not have to have high tolerance against wear or particle sticking as the particles do not tend to stick if they move slowly. Accordingly, contoured section 1200 may be made from readily available and/or inexpensive materials via a suitable process (e.g., machining, extrusion, etc.) In this sense, contoured section 1200 may be considered a consumable part that is relatively easy to replace in comparison with the CD section.

As shown in FIG. 12, flanged end 1202 may include exterior chamfered edges 1206 and 1208 and have an opening 1210 with a predefined exterior diameter (e.g., 075 inches). Flanged end 1202 may include collar 1212 that serves as an attachment point for connecting contoured section 1200 to the body of a cold spray gun. Collar 1212 may have a particular length (e.g., 0.25 inches). The size and/or shape of flanged end 1202 and collar 1212 may be configured for a particular cold spray system (i.e., cold spray equipment specific) as different cold spray systems may have their own configurations. The external diameter of contoured section 1200 may be, for example, 0.6 inches. Contoured section 1200 may include two flattened areas 1214 and 1216 (e.g., 0.25, 0.375, 0.464, or 0.5 inches in length and 0.267 in width) usable as anchor and/or leverage points to tighten contoured section 1200 with another section. Contoured section 1200 may be configured to be straight for a predefined length (e.g., 1.8 inches) before it is bent, for example, with a bend radius of 3 inches. Threaded end 1204 may include a portion (e.g., 0.438 inches) that is externally threaded in any manner and/or standard, for example, with ¾″-18 NPTF. Threaded end 1204 may include opening 1218 (e.g., 0.375 inches in diameter).

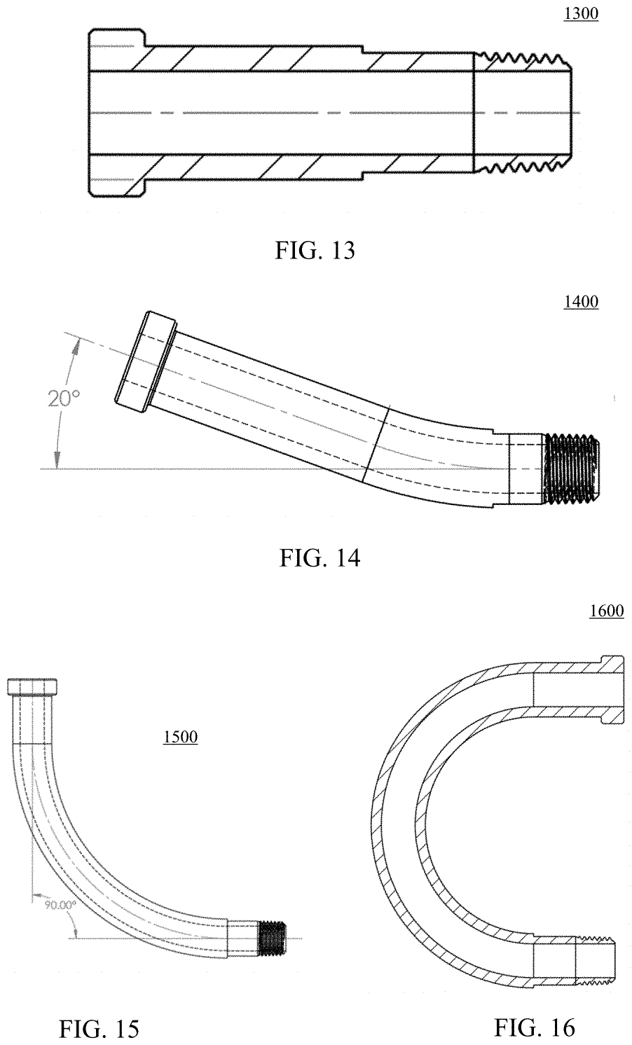

The contoured section shown in FIGS. 10-12 is merely an example. As the bend may be variable from 0° and above, other configurations of contoured section may be utilized for a nozzle assembly. Non-limiting examples of contoured sections are provided in FIGS. 13-16. FIG. 13 depicts a cross-sectional view of a section with bend degree of 0. FIG. 14 depicts an orthogonal view of a section with bend degree of 20. FIG. 15 depicts an orthogonal view of a section with bend degree of 90. FIG. 16 depicts a cross-sectional view of a section with a bend degree of 180. In operation, efficiency may be improved by having multiple contoured sections, each with a particular bend degree, such that one contoured section may be replaced with another contoured section, depending on the desired application.

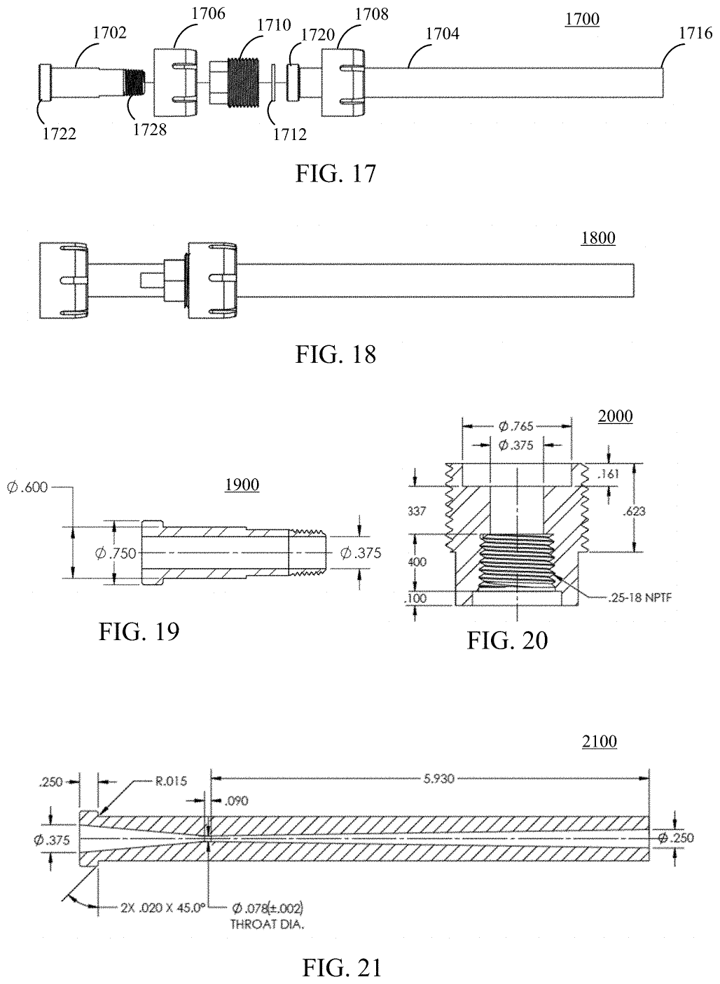

FIG. 17 depicts an exploded view of a nozzle assembly, according to an example embodiment. Nozzle assembly 1700 may include a first section 1702, a first coupling nut 1706, an adapter 1710, a washer 1712, a second coupling nut 1708 and a second section 1704. In this embodiment, adapter 1710 is a female-male adapter, but any suitable adapter may be used to implement adapter 1710. First coupling nut 1706 may be configured to be placed onto first section 1702 from first coupling end 1728 and moved up to flanged end 1722 before adapter 1710 is connected to first section 1702. Washer 1702 may be placed into adapter 1710 before it is connected to section 1704. Then, second coupling nut 1708 may be placed on second section 1704 at output end 1716 and moved up to flanged end 1720, over adapter 1710. In an embodiment, washer 1702 may be a sealing washer that is suitable for cold spray operation, i.e., can withstand the high temperature range of cold spray. In another embodiment, instead of or in addition to washer 1702, an adhesive may be used.

FIG. 18 depicts an orthogonal view of the nozzle assembly of FIG. 17. As shown in FIG. 18, nozzle assembly 1800 is a complete assembly of the various components shown in FIG. 17.

For purpose of illustration and not intended to be limiting, FIGS. 19-21 depict various components of a nozzle assembly with specific dimensions. These various components may be assembled together to form a nozzle assembly that has a bend degree of 0. FIG. 19 depicts a cross-section view of a first section 1900 of a nozzle assembly. FIG. 20 depicts a cross-sectional view of an adapter 2000. FIG. 21 depicts a cross-sectional view of a second section 2100 or CD section of a nozzle assembly.

### CONCLUSION

While various embodiments of the disclosed subject matter have been described above, it should be understood that they have been presented by way of example only, and not limitation. Various modifications and variations are possible without departing from the spirit and scope of the described embodiments. Accordingly, the breadth and scope of the disclosed subject matter should not be limited by any of the above-described exemplary embodiments.

What is claimed is:

1. A nozzle assembly for use in a cold spray deposition process, comprising:
a first section that has a flanged end and a first coupling end; and
a second section that has an internal converging section and an internal diverging section to allow powder particles to be accelerated toward a target, the second section comprising an output end of the nozzle assembly and a second coupling end configured to be coupled with the first coupling end.

2. The nozzle assembly of claim 1, wherein the first section and the second section are directly coupled with the second coupling end being configured to receive the first coupling end.

3. The nozzle assembly of claim 1, wherein the first coupling end comprises external threads and the second coupling end comprises internal threads.

4. The nozzle assembly of claim 1, wherein the first section and the second section are configured to be coupled via an adapter and a coupling nut.

5. The nozzle assembly of claim 1, further comprising a coupling nut configured to couple the flanged end of the first section to a cold spray system.

6. The nozzle assembly of claim 1, wherein the first section comprises a contoured section.

7. The nozzle assembly of claim 1, further comprising:
a treatment configured to reduce degradation and/or particle sticking.

8. The nozzle assembly of claim 7, wherein the treatment comprises at least one of titanium nitride, boron nitride, nitride, or diamond-like carbon.

9. The nozzle assembly of claim 7, wherein the treatment is provided on an internal surface of one or more sections of the nozzle assembly.

10. The nozzle assembly of claim 7, wherein the treatment is provided on an external surface of one or more sections of the nozzle assembly.

11. The nozzle assembly of claim 1, further comprising:
a third section configured to be coupled to at least one of the first section or the second section.

12. The nozzle assembly of claim 1, further comprising:
a gasket configured to be placed adjacent the second coupling end.

13. The nozzle assembly of claim 1, further comprising:
an adhesive configured to be placed adjacent the second coupling end.

14. A cold spray system, comprising:
a cold spray gun; and
a nozzle assembly that comprises
a first section that has a flanged end and a first coupling end; and
a second section that has an internal converging section and an internal diverging section to allow powder particles to be accelerated toward a target, the second section comprising an output end of the nozzle assembly and a second coupling end configured to be coupled with the first coupling end.

15. The cold spray system of claim 14, wherein the first section and the second section are directly coupled with the second coupling end being configured to receive the first coupling end.

16. The cold spray system of claim 14, wherein the first coupling end comprises external threads and the second coupling end comprises internal threads.

17. The cold spray system of claim 14, wherein the first second and the second section are configured to be coupled via an adapter and a coupling nut.

18. The cold spray system of claim 14, wherein the nozzle assembly further comprises a coupling nut configured to couple the flanged end of the first section to the cold spray gun.

18. The cold spray system of claim 14, wherein the first section comprises a contoured section.

19. The cold spray system of claim 14, wherein the nozzle assembly further comprises a treatment configured to reduce degradation or particle sticking.

20. The cold spray system of claim 14, wherein the nozzle assembly further comprises at least one of a gasket or an adhesive adjacent the second coupling end.
